(19) United States
(12) Patent Application Publication
(10) Pub. No.: US 2024/0373877 A1
(43) Pub. Date: Nov. 14, 2024

(54) ANIMAL FOOD PRODUCT AND METHOD AND APPARATUS THEREFOR

(71) Applicants: Broxton E. Ashburn, Asheville, NC (US); Michael W. Brennan, Raleigh, NC (US); Robert W. Bryant, JR., Gaithersburg, MD (US)

(72) Inventors: Broxton E. Ashburn, Asheville, NC (US); Michael W. Brennan, Raleigh, NC (US); Robert W. Bryant, JR., Gaithersburg, MD (US)

(21) Appl. No.: 18/662,742

(22) Filed: May 13, 2024

Related U.S. Application Data
(60) Provisional application No. 63/629,954, filed on May 13, 2023.

(51) Int. Cl. A23K 10/38; A23K 40/00; A23K 50/10

(52) U.S. Cl. CPC A23K 10/38; A23K 40/00; A23K 50/10

(57) ABSTRACT

A trub, hops and yeast mix (THYM), a problematic brewery side stream, has high amounts of antimicrobial hop metabolites and positive nutritional effects. Trub, hops and yeast wastes from fermenters, whirlpools, mash tuns, kettles, hopbacks, and grundies with pumps, sanitary piping and storage tanks are combined. Dewatering the mix caused an unexpected improvement in the stability and rheological properties of the THYM, allowing for greater material handling. Dewatering and drying may be by using one or more of filter bags, double drum dryers, rotary dryers, agitated mixing, and flash dryers. A dry product is produced which is suitable for pelletizing and/or packaging. THYM as a feed or supplement can improve weight gain in animals, enhance food flavors, stimulate rumen propionate synthesis, reduce methane production in vitro, increase bovine feed efficiency in vivo, positively alter the gut microbiome.

### CROSS REFERENCE TO RELATED APPLICATIONS

The present application claims the priority of U.S. Provisional Patent Application Ser. No. 63/629,954 filed May 13, 2023, entitled “A UNIQUE COLLECTION OF TRUB, HOPS, AND YEAST MIX (THYM) AND DEWATERING PROCESS TO PRODUCE AN EASILY HANDLED, MULTI-BENEFIT FOOD PRODUCT”, and which is incorporated herein in its entirety.

### GOVERNMENT RIGHTS

This invention was made with government support under Grant #2018-33610-28499 awarded by the USDA. The government has certain rights in the invention.

### SUMMARY

A dewatered residue of a brewing process provides an animal food with desirable characteristics.

A process of dewatering a residue of a brewing process provides an animal food product with desirable characteristics.

An apparatus dewaters a residue of a brewing process provides an animal food product with desirable characteristics.

A method to produce a food product includes collecting brewery wastes from at least one of: a fermenter, a whirlpool, a mash tun, a kettle, a hopback, or grundies, the brewery wastes comprising trub, hops, and yeast mix (THYM), a volume ratio of trub to spent yeast is between approximately 1:5 and 5:1, inclusive, a volume ratio of hot trub to cold trub is between approximately 1:5 and 5:1 inclusive, and the THYM has a combined hop acid content (alpha hop acid plus beta hop acid) between approximately 2 mg/g and 100 mg/g, inclusive, and dewatering the THYM until moisture content is reduced to between approximately 3 and 93%, inclusive.

A food product includes a custom mix of trub, hops, and yeast (THYM) brewery waste products with a moisture content of between approximately 3 and 93%, inclusive.

An apparatus for producing a food product from brewery waste products includes a feed for receiving a trub, hops, and yeast mix (THYM), first and second rotating drums, the drums rotating in opposite directions, the drums being heated to a temperature of between approximately 85 and 105° C., inclusive, the drums drying the THYM, the THYM being in contact with a drum for an appropriate amount of time for insuring an optimal final product, such as, for example, approximately 90 seconds, and a first scraper for scraping the THYM off the first drum and a second scraper for scraping the THYM off the second drum.

### BRIEF DESCRIPTION OF THE DRAWING

FIG. 1A shows the structures of the principal alpha-and beta-hop acids, the structure of the iso-alpha-hop acid resulting from the boil of Humulus lupulus hop cones, and the structure of xanthohumol, another bioactive compound in hop cones.

FIG. 1B shows the structure of Xanthohumol.

FIGS. 2A and 2B illustrate the results of an agar diffusion assay showing that craft brewer's yeast has antimicrobial activity.

FIG. 3 shows that including THYM in the diet alters the microbiome of the chicken cecum and increases the abundance of the family Flavonifractor or Pseudoflavonifractor.

FIG. 4 shows a TLC chromatogram of THYM (lane B) and spent craft yeast (lane A) extracts indicating that THYM has approximately 10 times more hop acids than spent yeast.

FIG. 5 shows that THYM stimulates the production of propionate and decreases the acetate/propionate (A/P) ratio in bovine rumen incubations.

FIG. 6 shows that blood urea nitrogen (BUN) is significantly lower in THYM and Rumensin® fed animals suggesting improved rumen nitrogen metabolism.

FIG. 7 demonstrates use of a USDA-type consistometer to determine material flow properties.

FIG. 8 shows that dewatering causes an unexpected significant increase in THYM stiffness.

FIG. 9 Illustrates a double drum dryer and process that unexpectedly reduced the moisture content of THYM.

FIG. 10 shows the comparative shelf stability of drum-dried v. spray-dried hop acid content in vacuum sealed bags.

FIG. 11 shows inhibition of methane production in bovine rumen microbes incubated anaerobically for 24 hours at 39° C. with a silage: corn substrate.

FIG. 12 show an Image from the magazine “Capital at Play” highlighting the sales of Asheville Brew Bites which were a confection that contained 5% by weight of hop acid rich spent craft yeast and were credited with having an unusual and interesting flavor.

### DETAILED DESCRIPTION

A unique combination of craft brewing residue, such as brewing co-product liquids, and trub, hops, and yeast mixes (THYM) is dewatered to provide a product with high antibiotic properties. The product is a high value, easily handled, animal feed and feed supplement food product.

Disposal of wastes at small to medium sized breweries is problematic. The brewing process generates several principal waste streams: spent grain, spent yeast, trub (a complex mixture largely of polyphenol-protein precipitates), and spent hops.

These waste streams of the craft brewing process have nutritional value, but only spent grain is widely used for feed. The nutritional value of spent brewer's grain for livestock is well known and is widely accepted. While spent grain has long had a demand as feed, waste trub, hops and yeast from craft brewing have typically been ignored as value added co-products because these materials have a high water content, a runny consistency, and spoil rapidly. As a result, they are often disposed of via municipal sewer systems. Such disposal at small to medium sized breweries is costly, both to the brewery in terms of waste disposal fees, and to municipal sewer and wastewater treatment systems in terms of added biological oxygen demand (BOD) and total suspended solids. In contrast, large commercial breweries have industrial-grade pretreatment and removal systems available to handle yeast, trub and hop waste products.

Trub and spent yeast, however, have an even greater nutritional value on a protein basis than spent grain; their protein content, 49% and 47% respectively, is twice that of spent grain. Dried mixtures of trub and spent yeast were found to be accepted by cows and pigs despite some bitterness as long as their concentration in feed did not exceed 20%. In a study of 90 craft breweries in the UK, roughly 60% of the spent yeast slurry went down the sewer, 20% went as fertilizer, and 10% was used for compost. As noted above, the waste streams are watery, have a high moisture content (85-90%), and so are difficult for the craft brewer to process.

Craft beer styles typically use large amounts of hops. An average craft brewing process can use in excess of 1.5 pounds of hops per barrel (31 gallons), which is four times higher than used for production of beers made by large commercial breweries. Although craft brewing represents about 10% of the beer market it uses more than 40% of the total hops produced for brewing. Spent yeast from craft brewing has high amounts of antibiotic hop acids, five-fold greater than the levels measured in spent yeast from large commercial brewers. For the alpha-acids, which are generally the most abundant class in commercial hops, the level was twelve times higher in spent yeast from craft brewers than yeast from large commercial brewers. Also, yeast strongly absorbs hop acids from the fermenting beer.

TABLE 1 shows the high levels (μg/g) of anti-microbial compounds, such as prenylated flavonoids, and hop acids present in THYM. Spent craft yeast and THYM samples were subjected to solid phase methanol extraction and hop metabolites were measured by High-Performance Liquid Chromatography (HPLC) vs. authentic standards. The measured levels are expressed on a dry weight basis, μg/g.

TABLE 1

| Sample | Xanthohumol | α-Hop Acids | β-Hop Acids |
|---|---|---|---|
| THYM | 2,789 | 11,249 | 13,258 |
| Spent Yeast | 316 | 921 | 129 |

While the elevated hop acid level in spent craft brewer's yeast is interesting, it was surprising and unexpected to find that the elevated hop acid level was associated with strong antibiotic properties of the yeast itself. Thus, spent yeast from craft brewing, in addition to its high protein content, also demonstrates unexpectedly high antibiotic activity.

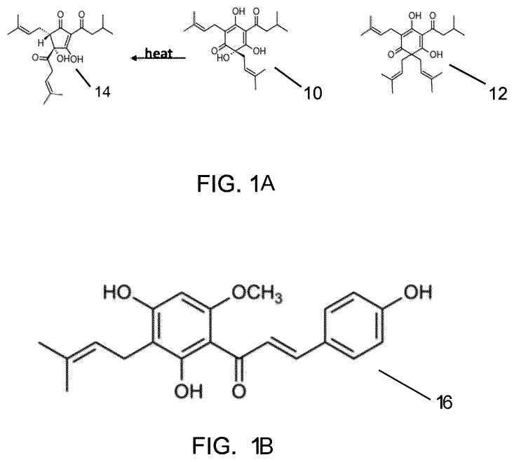

The three main classes of acids are alpha-acids (humulones), beta-acids (lupulones), and iso-alpha-acids (iso-humulones). FIG. 1A shows the structures of some of the principal alpha hop acids 10, beta hop acids 12, and the structure of the iso-alpha hop acid 14 resulting from the boil of Humulus lupulus hop cones. The latter are formed when the hops are heated during the boiling phase of beer production. Xanthohumol 16, is a polyphenol, only found in hops. See FIG. 1B. While craft beer styles generally utilize high levels of hops in their recipes, the hopping rate (amount), hop strain and process method varies from style to style. The alpha-and beta-acids (aka humulones and lupulones) have high antibiotic activity while the iso-alpha-acids, created during the boiling phase of brewing, have lower antibiotic activity but provide greater bitterness for flavoring purposes. Not indicated are the ad-and co-isomers of each structure type which have similar activity profiles. Xanthohumol has shown promising potential to improve gut function among other metabolic benefits. The content of hop acids and xanthohumol in trub, hops and yeast in waste streams will vary from style to style of the brewery product being made.

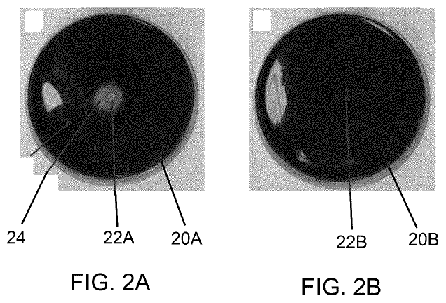

FIGS. 2A and 2B illustrate the results of an agar diffusion assay showing that craft brewer's yeast has antibiotic activity. In this experiment, petri dishes 20A, 20B were seeded with the Gram-positive bacteria Clostridium stricklandi. Clostridium sticklandii SR, a hyper ammonia producer isolated from a mixed bovine rumen bacteria culture, was seeded as a lawn on agar. A plug, about 100 mg, of spent craft brewer's yeast was placed in center 22A of plate 20A, and a plug of baker's yeast (a similar yeast but not containing hop acids) was placed in the center 22B of plate 20B. Both yeast samples had been heat inactivated prior to being placed on the plates 20A, 20B. The plates 20A, 20B were incubated anaerobically overnight and the bacteria were stained. The clear agar zone 24 of growth inhibition around the plug on plate 20A shows the antibiotic effect of the craft brewer's yeast, while there was no clearing with baker's yeast on plate 20B.

In another experiment, a similar, strong zone of inhibition was observed around a sample of craft yeast placed on an agar plate seeded with Bacillus cereus, another Gram-positive bacteria. In contrast, barely discernible zones were seen with spent yeast samples from large commercial breweries. Further research involving biochromatography suggests that the high level of hop acids in spent craft yeast is playing a role in its antibiotic properties. Note, in contrast to spent craft yeast, barely discernible zones were seen with spent yeast samples from multinational breweries supporting the argument that the higher level of hop acids in spent craft yeast conferred antibiotic activity.

In some studies, utilizing caprine (goat) rumen microbes, spent craft yeast suppressed the undesirable production of ammonia, improving availability of nutrient amino acids for the animal, and caused a ten-fold reduction in the numbers of hyper ammonia producing bacteria. Other studies found that small amounts of spent craft yeast, 2% final concentration, suppressed rumen microbial methane production by more than 25% in bovine and 61% in caprine rumen microbial incubations. Although there is also literature demonstrating that whole hops, hop extracts and purified hop acids have antibacterial effects, the above experiments were the first to show that craft brewing waste products, e.g., spent yeast, had antibiotic effects in its own right.

TABLE 2 shows that THYM causes greater inhibition of rumen microbial methane production than by either spent yeast or the antibiotic monensin (Rumensin®).

TABLE 2

| | Methane Production (ppm) | | | | |
|---|---|---|---|---|---|
| | Control | | Experiment | | |
| Test Agent | AVG | SD | AVG | SD | Inhibition |
| Yeast (2% | 10627 | 836 | 7670 | 274 | 28% |
| THYM (0.4%) | 32975 | 5184 | 6608 | 1413 | 80% |
| Monensin (10 μM) | 35384 | 7457 | 11152 | 1493 | 68% |

N = 3 or 4, p < 0.05 for all

Further work on the antimicrobial activity of purified alpha-acids and beta-acids on gram positive bacteria showed that they also have ionophoric activity. These hop acids allow for hydrogen, potassium, and other ions to pass through the Gram-positive cell wall, altering the bacterial membrane potential and preventing growth in a manner similar to other antibiotic ionophores, e.g., monensin. However, as with monensin, alpha-acids and beta-acids do not inhibit growth of Gram-negative organisms.

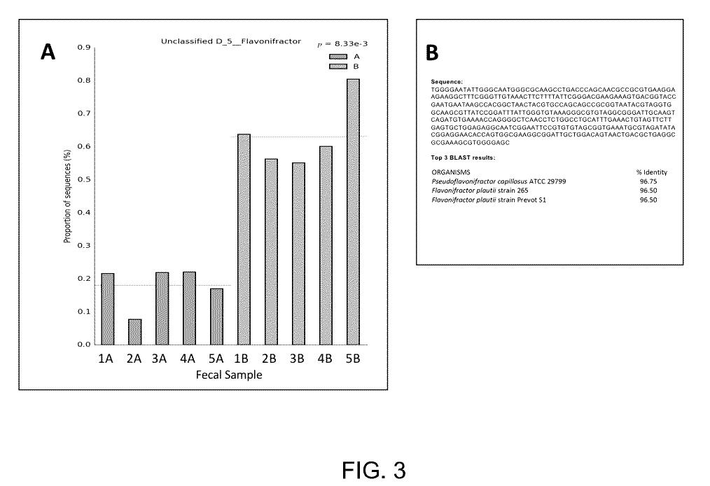

The Gram-positive selectivity of hop acids has beneficial metabolic effects on the very diverse microbial population in the rumen and, by inference, the gastro-intestinal (GI) tracts of humans, other animals and insects. Propionic acid, made largely by gram negative organisms, is not altered by hop acids while acetic acid formation often is. As propionate is a precursor for glucose production in ruminants, an increase in the propionate-acetate ratio is thought to be one of the growth-promoting aspects that occurs with monensin. Likewise, hop acids inhibit lactic acid formation and blunt the undesirable pH drop that is often triggered by gram positive organisms e.g., S. bovis. Hop acids and monensin also suppress protein and amino acid (“bypass” protein) degradation by gram positive bovine and caprine hyper-ammonia producers. Recent studies in broiler chickens indicated that 1% THYM in their diet altered the microbiome by increasing the amount of the Flavonifractor genus (FIG. 3). While the nutritional effect of this change with THYM is unknown, Flavonifractor plautii abundance was increased with green tea in mice and associated with a reduction in GI inflammation.

FIG. 3 shows that THYM alters the microbiome of the chicken cecum and increases the abundance of the family Flavonifractor or Pseudoflavonifractor. Panel A shows the significant increase (from 0.2% to 0.6%, p<0.009) in abundance of an OTU, an unclassified Flavonifractor. Panel B shows the 400 base sequence of the enhanced OTU AND NCBI-BLAST results of the three closest matches.

The craft beer co-product spent yeast is rich in hop acids and antimicrobial activity.

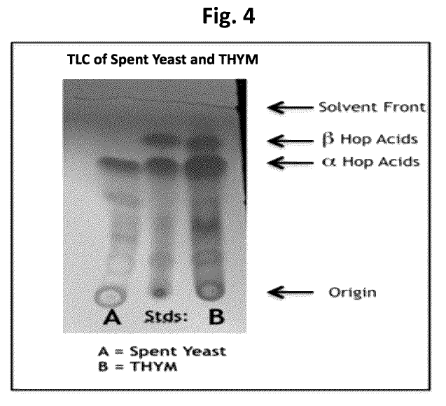

FIG. 4 shows a thin layer chromatography (TLC) chromatogram of THYM (lane B) and spent craft yeast (lane A) extracts indicating that THYM has approximately 10 times more hop acids than spent yeast. Diethyl ether methanol extracts of spent yeast and THYM were spotted on silica gel F254 plates and developed in hexane:ethyl acetate: acetic acid, 85:15:1. Spots were observed under UV light and compared to authentic standards (“Stds” lane). THYM has an even higher level of antibiotic compounds. Follow-up HPLC studies (TABLE 1 above) showed greater than 10 mg/g dry weight for each of the alpha and beta hop acids and 2.5 mg/g of xanthohumol, another antibacterial and anti-methanogenic compound. These levels are much higher than in spent craft brewer's yeast by 10 and 100-fold, respectively for alpha-acids and beta-acids respectively. These high levels of antimicrobial compounds in THYM translated to much greater inhibition of methane productions (TABLE 2 above) than seen in initial, published observations with spent craft yeast.

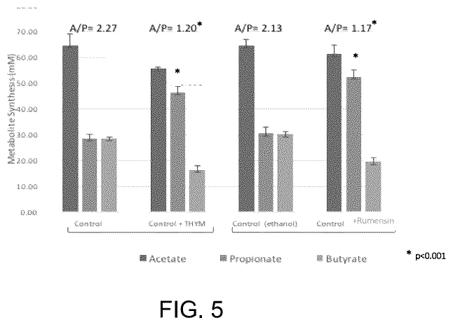

FIG. 5 shows that THYM stimulates the production of propionate and decreases the acetate/propionate (A/P) ratio in bovine rumen incubations. After collection of headspace gas samples from the incubations, aliquots of incubation media were acidified, frozen and later submitted to anion exchange HPLC to measure concentrations of acetate, propionate and butyrate. The brackets below the graph show the paired experiments. The acetate: propionate ratios A/P are shown above the experiments.

Additional studies, outlined herein, have found that THYM, with its unexpected high antimicrobial activity, has significant positive effects on digestion. THYM suppresses pH drop and increases the propionate/acetate ratio in unfractionated bovine rumen microbe incubations. THYM was also found to have a very pronounced inhibition of methane production by rumen microbes. THYM caused 80% inhibition at a modest concentration of 0.4% of DM, which exceeded the inhibition by Rumensin®, 68%, used at a high level of 10 μM. Likewise, THYM more strongly inhibited rumen methane production than did spent craft yeast (TABLE 2). Furthermore, THYM caused an increase in the desirable propionic acid and decreased in the acetate: propionate ratio (FIG. 5). In an unpublished study, anaerobic bovine rumen fluid incubated for 24 hr. with 0.3% of THYM resulted in a metabolic pH increase of 0.2 pH units, reduced methane production by 23%, and likewise improved the propionate: acetate ratio.

THYM has other bio-active metabolites in addition to-and B-hop acids. In particular it is rich in the polyphenolic phytoestrogen xanthohumol XN, as has been mentioned above. Averaging results from 10 separate preparations of THYM over 3 months XN content was 1.4+1 vs 25.4+11.6 mg/g for a-hop acid and 15.2+6.2 mg/ml B-hop acids. Significant levels of xanthohumol metabolites were found in the blood of the Angus steers fed diets containing 1% THYM as shown in TABLE 8. XN and dihydro-xanthohumol (DXN) have been shown to suppress colon cancer and 8-prenyl naringenin (8PN) is the very potent natural estrogen with other positive metabolic aspects.

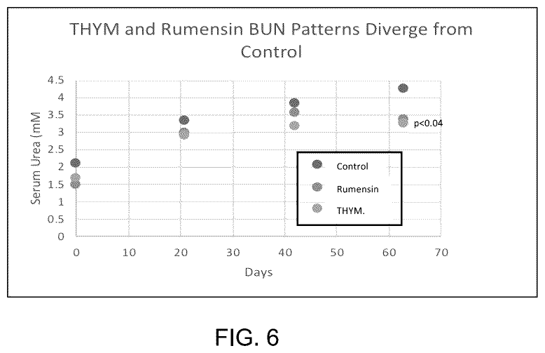

FIG. 6 shows that the blood urea nitrogen (BUN) level is significantly lower in animals fed THYM and Rumensin® during a feed trial, suggesting an improved (more efficient) rumen nitrogen metabolism.

TABLE 3 shows improved feed efficiency in beef cattle with THYM feed supplementation.

TABLE 3

| | Gain to Feed Ratio³ | Average Daily Gain |
|---|---|---|
| | (kg/kg) | (kg/day) |
| Control | 0.36 | 1.54 |
| Monensin¹ | 0.38 | 1.65 |
| THYM | 0.40 | 1.72 |
| % Increase² | 11% | 12% |

Improved Weight Gain and Feed Efficiency in Beef Cattle with THYM Supplement⁴
¹Rumensisn ®
²THYM over control
³for M & T vs C p = 0.07
⁴Weanling Angus-X steers, weight 320 ± 21 kg, were fed for 9 weeks on a 67% corn silage:12% soybean meal:11% corn with minerals and limestone as is (Control) or plus monensin at 200 mg/animal (Rumensin) or plus 1% THYM in the rations (THYM).

The brewery co-products trub, spent hops and spent yeast are typically 80-90% water making disposal difficult and burdensome to most craft breweries. A modest reduction of the moisture content of trub, spent hops and spent yeast materials greatly improves case of handling. The non-dewatered mixture of the three is quite runny and can only be handled with a bucket or similar container. After dewatering using a filter bag the material can be handled with a standard multiprong fork, e.g., an ensilage fork. To document this rheologic change we utilized a consistometer test.

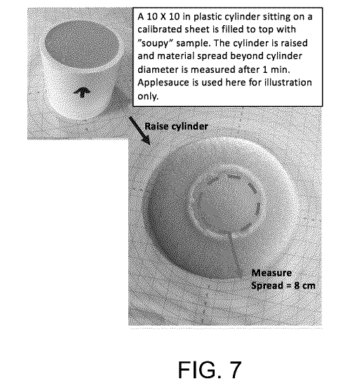

FIG. 7 demonstrates use of a USDA-type consistometer to determine material flow properties. A commercial sample of applesauce serves as a control experiment. A simple test is shown which illustrates the spread of commercial applesauce, 8 cm in this test. This spread was reproducible and sensitive to the amount of dry matter in the sample.

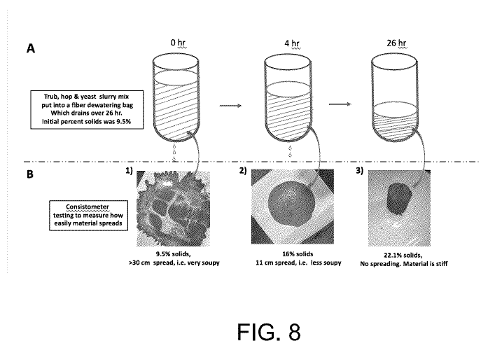

The dewatering process and rheology change of THYM is shown in FIG. 8. The upper panel, A, shows dewatering process for a mixture of trub, hops and yeast put into a porous bag and left, in this example, for 26 hours. There is a reduction in volume as water drains away leaving the great majority of the solids in the bag as illustrated in the diagram. The lower panel, B, shows the consistometer test results for THYM samples taken from the bag at 0, 4 and 26 hr. The first time sample (0 hr), taken at beginning of the process, shows great spreading, >30 cm which indicates that the material has a very soupy or runny consistency. The material at the next time sample (4 hr), shows a reduced spreading of 11 cm, while the material at the last time sample (26 hr) shows no apparent spreading and hence high stiffness. The first sample (“1)”) in panel B needs a bucket or other liquid handling equipment to move, while the third sample (“3)”) in panel B can be moved with a variety of farm equipment meant for handling feed, e.g., grain augers, front loaders etc.

Adding a filter aid, such as diatomaceous earth (DE), improved THYM slurry (93% moisture) vacuum filtration speeds up to 16-fold with addition of 6% DE (w/v). The resultant filter cake had a reduced moisture content of 55% and complete retention of antimicrobial hop acids. Attempts to further dry these THYM-DE filter cakes without loss of antimicrobial hop acids were very problematic. Loss of Hop acids paralleled loss of moisture in THYM-DE samples air dried at 60 C over 17 hr. as shown in TABLE 4. The heat lability of hop acids was further noted when THYM was stored for a week at 39° C. caused a >80% loss of a-and B-hop acids in comparison to samples stored at 22 to 24° C.

TABLE 4 shows that drying THYM-DE at 60° C. causes loss of key hop metabolites.

TABLE 4

| | | Metabolite % vs Unheated Samples | | |
|---|---|---|---|---|
| Drying time | Moisture | XN | AA | BA |
| 0 | 58% | 100% | 100% | 100% |
| 2 | 44% | 100% | 115% | 88% |
| 6* | 2% | 71% | 39% | 4% |
| 17 | 2% | 66% | 31% | 7% |

*Sample stirred every 2 hours

However, unexpectedly, THYM-DE dried very well under a stream of air at 25° C. over 2 hours as shown in TABLE 5.

TABLE 5 shows results with small scale air drying studies with THYM-DE. Drying at 25° C. was effective but drying at 102° C. caused hop acid loss. A THYM slurry was filtered with aid of a 2% (w/v) Diatomaceous Earth (DE). The cake was broken up and 5 gram portions were spread on aluminum foil and either subjected to a stream of air at 25° C. or placed in a 102° C. oven. Portions were removed at various times assayed for moisture and hop acid content.

TABLE 5

| | | Hop Metabolite | | |
|---|---|---|---|---|
| | Moisture | Content (mg/g DM) | | |
| Filter Cake Drying Temp | Content | XN | HA-A | HA-B |
| Undried | 59% | 1.3 | 24.8 | 12.7 |
| 25° C. air stream for 2 hours | 10% | 1.5 | 28.2 | 13.3 |
| 102° C. oven for 1 hr. | 4% | 1.0 | 8.9 | 0.8 |

Although one might expect that dewatering a slurry will provide some increase in stiffness, FIG. 8 shows that dewatering causes an unexpectedly significant increase in THYM stiffness. Section A shows dewatering process for a mixture of trub, hops and yeast put into a porous dewatering bag and left for 26 hours with volume reduction as water drains away leaving the great majority of the solids in the bag.

Section B shows the consistometer results for THYM samples taken from the bag at 0, 4 and 26 hours. The time “0 hr” sample, taken at beginning of dewatering process, shows great spreading, greater than 30 cm, which indicates that the material at “1)” initially has a very soupy or runny consistency. The material at 4 hr., “2)”, shows reduced spreading of 11 cm, while the material after 26 hr. of dewatering, “3)”, shows no apparent spreading and hence high stiffness.

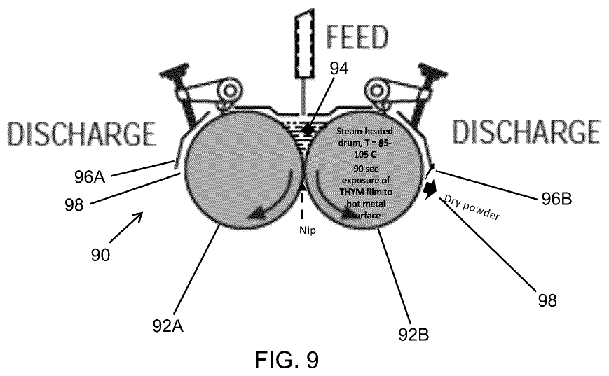

FIG. 9 illustrates a double drum dryer 90 and process that unexpectedly reduced the moisture content of THYM from 90-95% to 6% or less in a short time, with excellent, high retention of heat-labile, antimicrobial hop acids. In an embodiment, the drums 92A, 92B of the dryer were steam-heated to a temperature of 85 to 105° C. The THYM film 94 was exposed to the hot metal surface of the drums for about 90 seconds before being scraped off the drums as a dry powder 98 by the drum scraper blades 96A, 96B.

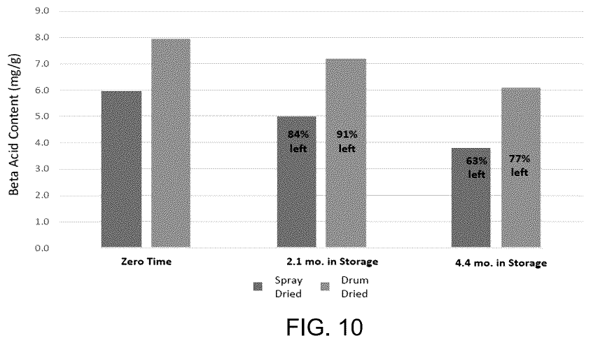

FIG. 10 shows the comparative shelf stability of drum-dried vs. spray-dried hop acid content in vacuum sealed bags. Note the higher initial levels (at “Zero Time”) of hop acid in samples dried with a double drum dryer versus those dried with a spray drier. Also note the higher retention of these hop acids over time for the drum dried product (at “2.1 mo. in Storage” and at “4.4 mo. in Storage”). Thus, drum drying THYM preserves more beta acids than spray drying and they last longer in storage.

Spent yeast and related waste streams spoil in a few days when stored outdoors in “Summer Temperatures”, 20 to 30° C. However, aging studies with THYM samples stored in a refrigerator (T=4 to 5° C.) or outdoors (Asheville, NC, T=20 to 30° C.) showed that sample appearance and hop acid concentrations in THYM remained high (>75% of control) even after 33 days of storage outside. While it was expected that THYM stored under refrigeration would provide superior stability and protection against spoilage, the fact that THYM stored outdoors in warmer temperatures also exhibited improved stability was unexpected. A good shelf life during ambient storage adds to value and usefulness.

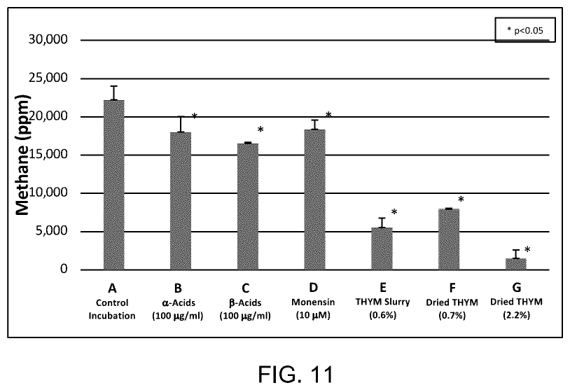

TABLE 6 provides a comparison of selected drying technologies that were evaluated on several important metrics. Several commercial scale dewatering systems were evaluated. Unexpectedly, high temperature double drum drying (FIG. 9) of THYM resulted in excellent yields of powders of moisture contents of 6% or less and hop metabolite recoveries of >80% as shown in TABLE 7 where data from several batch runs are shown. This drum dried THYM was found to retain its ability to inhibit rumen microbial methane production as shown in FIG. 11. As noted in the figure legend, THYM incubations had a roughly similar content of hop acids (160 μg/ml) to incubations where purified hop acids were added, i.e., 100 μg/ml, yet THYM produced a much greater degree of methane inhibition. This observation suggests that THYM is an unexpectedly superior delivery vehicle for antimicrobial hop acids. The possibility that other factors in THYM contribute methane inhibition is discounted by studies with spent yeasts from different beer styles. Inhibition of rumen microbial methane was directly related to the hop acid content.

TABLE 6

| | | Vacuum | | | |
|---|---|---|---|---|---|
| | Atmospheric | Drum | Filter | Filter | Spray |
| | Drum Dryer | Dryer | Press | Bag | Dryer |
| Moisture | High | High | Moderate | Low | Moderate |
| Removal | | | | | |
| Ease of | Low | Low | Moderate | High | Moderate |
| Installation | | | | | |
| Production | Moderate | Low | Moderate | High | Moderate |
| Volume | | | | | |
| Flexibility | | | | | |
| Cost | Moderate | High | Moderate | Low | High |
| Ease of Use | High | Low | Moderate | Low | Moderate |
| One Step | Yes | Yes | No | No | Potentially |
| Process | | | | | |

TABLE 7 shows unexpected excellent recovery of THYM hop acids high temperature, short exposure drum drying. Drum drying THYM provides for excellent moisture loss and metabolite recovery.

TABLE 7

| | Drum Drying Parameters | | | | | | |
|---|---|---|---|---|---|---|---|
| | Steam | Nip | Evaporation | | Metabolite Content (mg/g) | | |
| THYM | Pressure | Temp. | Rate | | | Alpha | Beta |
| Batch | (psi) | (° F.) | (lb/hr/sf) | Moisture | XN | Acids | Acids |
| Starting | | | | 93% | 0.6 | 10.7 | 6.7 |
| Slurry | | | | | | | |
| C | 44 | 193 | 5.5 | 5% | 0.5 | 8.0 | 4.9 |
| D | 46 | 194 | 6.0 | 4% | 0.6 | 9.0 | 5.2 |
| E* | 50 | 205 | 7.6 | 6% | 0.6 | 9.2 | 5.4 |

*Recovery of XN, α-acids and β-acids for Drum Dried Batch E was 104%, 87% and 81%

TABLE 8 shows that, for Angus Steers fed a diet containing 1% THYM, which contains 3 mg/g of xanthohumol, the metabolite serum concentration of anti-tumor and estrogenic prenylated flavonoids was raised.

TABLE 8
Metabolite Serum Concentration (nM)

| | Animals | XN | | DXN | | IXN | | 6PN | | 8PN | | DDXN | |
|---|---|---|---|---|---|---|---|---|---|---|---|---|---|
| Treatment | Tested | Mean | SD | Mean | SD | Mean | SD | Mean | SD | Mean | SD | Mean | SD |
| Control | 4 | UD¹ | | UD | | UD | | UD | | UD | | UD | |
| THYM | 8 | 7.3 | 1.7 | 5.2 | 1.3 | 0.5 | 0.4 | 6.9 | 1.5 | 4.0 | 0.9 | 1.0 | 0.2 |

¹Undetected

TABLE 9 shows a custom mix of THYM-utilizing beers with different hopping rates and differing distribution of hop additions during the brewing process. This study resulted in a THYM mixture containing preferred levels of crude proteins, other key nutrients, alpha hop acid levels of ˜25 mg/g, and beta hop acid levels of ˜20 mg/g.

TABLE 9

| | Beer A | Beer B | Beer C |
|---|---|---|---|
| Hopping rate (lb/barrel) | 2.28 | 1.28 | 0.46 |
| Hop Distribution Rate | | | |
| at Stage of Production | | | |
| Kettle | 12% | 2% | 24% |
| Whirlpool | 35% | 59% | 76% |
| Dry Hopped | 53% | 39% | 0% |
| Source/Type of Hops | Apollo, | Apollo, Cascade, | Chinook, |
| | Centennial, | Chinook, Bravo, | Cascade, |
| | Citra | Centennial | Wilamette |

FIG. 11 shows inhibition of methane production by rumen microbes by use of hop acids and drum-dried THYM. Bovine rumen microbes were incubated anaerobically for 24 hours at 39° C. with a silage: corn substrate. Bar A indicates basal control incubation, and bars B-G indicate additions. The purified hop acids (Bars B & C) were added as sodium salts to improve solubility; THYM (Bars E-G) was either in slurry from (93% moisture) or drum dried form (5% moisture). Monensin (Rumensin) was used as a positive inhibitory control. The hop acid content of the THYM samples in incubation bars E & F was 100 and 60 μg/ml for alpha and beta acids respectively, similar to the concentrations of alpha and beta acids, 100 μg/ml, added in bars B and C. Yet THYM samples gave substantially greater methane inhibition, suggesting that proteinaceous/fibrous THYM is a superior delivery vehicle for the sparingly soluble alpha and beta hop acids.

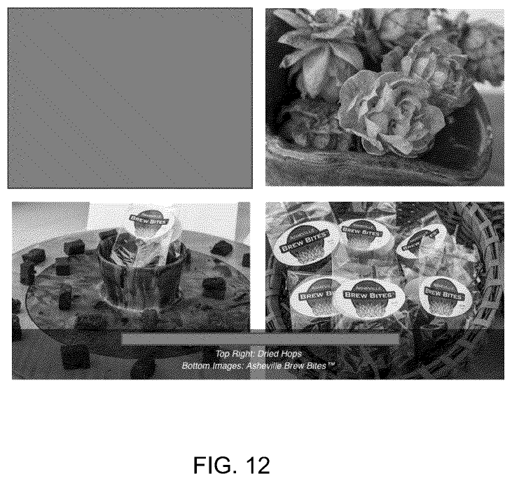

FIG. 12 shows an image captioned “Selling Asheville Brew Bites™ at the Montford Farmer's Market” from the magazine “Capital at Play,” highlighting the sales of Asheville Brew Bites, a confection containing 5% by weight of hop acid rich spent craft yeast, and credited with having an unusual, interesting flavor.

The results discussed herein show that the craft brewing co-product THYM could have considerable value as a feed supplement for ruminants and other species by virtue of its natural antimicrobial properties. Additionally, nutrient analysis of THYM reported a protein content of 35 to 44% of DM. Based on published values for spent brewers' yeast amino acid profiles we expect that THYM will have a favorable amino acid profile for ruminant nutrition.

The unusual high biological activity of co-products of craft brewing, i.e., THYM, has not been previously recognized nor anticipated based upon hop acid analysis of conventional beer side streams. We believe THYM will be the basis of a novel and environmentally friendly feed supplement. While hop cones have been proposed as a feed supplement, their high price could discourage such use. The embodiments disclosed herein turn substantial craft brewing co-product liquids, which are disposal headaches, into advantages for the brewer, farmer and municipal waste processor. Further, utilization of hop rich brewing waste streams as feed supplements are an improvement over the use of hop extracts or dried hop preparations. Hops represent a considerable percentage of ingredient costs for the craft brewer and the embodiments herein enable some cost recovery of this valuable commodity.

A recent review of approximately 150 studies looking at improving food industry side stream usage concluded “Despite a plethora of studies carried out on the utilization of side streams, relatively few processes have yet found industrial application.” The embodiments and disclosures herein will lead to recovery of half a million tons of nutrient rich previously ignored craft brewing side streams.

The United Nations predicts that feeding the world's growing population will require a doubling of global food production by 2050 to meet demands. Increasingly, as developing countries gain wealth, they consume more protein rich foods which are often derived in one form or another from farm animals. Farm animals are large producers of methane, contributing up to 44 percent of all human-caused methane, according to the Reuters news service. Methane is an even more powerful heat-trapping gas than CO2. Methane accounted for about 16% of global greenhouse gas emissions in 2015, according to the IPCC. The U.S. Environmental Protection Agency reports that, when measured in pounds, the effect of methane on climate change is more than 25 times greater than carbon dioxide over a 100-year period. The current craft brewery waste stream trub+hops+yeast mix (THYM) has the potential to mitigate animal methane production.

Based upon its demonstrated ability to improve biochemical nutrition parameters in the ruminant GI tract, THYM has potential as a feed additive for animals including but not limited to the following: humans, swine, poultry, fish, orthoptera (crickets, grasshoppers, and locusts), sheep, goats, alpaca, house pets (including but not limited to dogs, cats, birds, gerbils, etc.),

Based upon its high content of hop acids and other, natural aromatic compounds THYM could enhance flavor of foods directly or indirectly as a feed additive.

Overall, alpha-and beta-acids have similar aspects to ionophoric growth promoters, e.g., monensin (Rumensin). As far as known, these hop acids do not carry the toxicity observed with compounds like monensin and could be a good substitute for it. It should be noted that the embodiments herein maximize retention of these antimicrobial hop acids, which are also phytonutrients, aka phytochemicals. Previous waste collection and drying procedures have ignored these important phytochemicals and in fact sought to reduce their content and contributions to bitter taste.

Hop rich craft brewery coproducts have functioned as flavor components in food. While hops, with their bitterness and aromatic attributes, are a key flavoring ingredient in beer, they have also been touted as a unique flavorant for foods, e. g. ice creams and stews. Hop acid rich spent craft yeast was even found to enhance the flavor of a brownie-like chocolate snack. In the embodiments herein, THYM has a high hop acid concentration and represents a potential potent flavorant.

Craft breweries produce large quantities of the components of THYM, so it has the potential for economic importance. Better use of these craft brewing co-products, i.e. trub, hops and yeast, as in the embodiments herein, could have lasting positive effects for craft breweries. The following points outline the overall rate of growth and impacts of craft breweries through 2019 and indicate opportunities and needs for improved waste stream recovery:
There are over 8,000 craft breweries in the U.S;
There are over 26 million barrels (31 gallon unit of measurement) of craft beer (more than 800 million gallons of craft beer) produced annually;
Many craft breweries have opened in old urban industrial areas and abandoned factories;
Breweries are high users of water and generate significant waste streams; and
Craft breweries are very eager to mitigate their environmental impact.

The valuable, hop acid and protein rich co-products from craft breweries are underutilized because: 1) their potential as a cattle growth promoter and ruminant methane inhibitor has not been recognized before; and 2) conventional processing methods for these runny or soupy materials are too expensive for many craft breweries.

The embodiments herein include a unique mixture of the trub, hops, and yeast co-products of craft brewing. This unique mixture has unexpected strong natural antimicrobial properties which confer beneficial nutritional effects on ruminant GI metabolism. This unique mixture provides a valuable protein source, has natural antibiotic properties, reduces methane production in cattle, and can improve the rate of weight gain in animals by virtue of its ability to reduce protein degradation from ammonia, and to increase rumen propionate synthesis. This unique mixture, however, has a soupy consistency which makes it difficult for brewers and farmers to manipulate. Therefore, the embodiments herein also include methods to achieve a significant reduction in moisture content of THYM, with an unexpected improvement in its rheological properties. This consistency change produces a de-watered feed product for animals that is much casier to handle.

Furthermore, and unexpectedly, high temperature double drum drying produces a stable dry powder (approximately 5% moisture), with high recoveries of heat-labile hop acids, which can then be packaged and sold to end users as a feed supplement. In addition, the drum drying approach resulted in high retention of crude proteins, digestible fiber and other valuable nutrients. Also, drum drying THYM preserves more beta acids than spray drying and these beta acids last longer in storage.

A clear advantage of drum drying over other methods is the one step nature of the process. Raw THYM is a very difficult substance to handle due its high moisture content and even when dried to 70 to 80% moisture it is sticky and difficult to handle. The drum dryer, in a single step, provides flash pasteurization and creates a shelf stable powdered product that is immediately ready to package and store. A novel and unexpected outcome of the drum drying process is that the dried product retains more of the valuable hop acids initially present than other drying techniques, notably spray drying. In addition, an unexpected outcome is that the drum drying process also produces an end product that retains more of the hop acids over time, as compared with other forms of drying, when stored in vacuum sealed bags.

FIG. 11 shows higher initial levels of hop acid in samples dried with a double drum dryer versus those dried with a spray drier (see Time Zero bars), and also shows a comparison of the shelf stability of drum dried vs. spray dried hop acid content in vacuum sealed bags.

While drum drying has obvious advantages in terms of full removal of the waste stream and minimal handling of the product, other drying technologies may also be used, although with possibly reduced benefits. These other methodologies include, but are not limited to, filter cloth/bags, filter presses, fluid bed dryers, spray dryers, high volume air drying, and lyophilization. Exemplary steps for using THYM are set forth below.

Three waste components described above, namely trub, hops and yeast are custom mixed and stored until ready for dewatering or pumped directly to the system in step three or four.
A. The preferred mixtures will be based on volumetric ratios of trub, hops and yeast from multiple beer production runs.
B. These ratios are developed to produce a mixture with consistent and predictable levels of crude protein, digestible fiber, hop acids (alpha and beta) and other key nutrients and minerals.
C. The precise mix ratio in each batch will primarily be based on the following attributes for each the candidate beer style and production run (See TABLE 9 for a sample recipe):
   i. Hopping rate and type of hops (lbs/barrel)
   ii. Percent dry hopped
   iii. Percent and timing of hopping in kettle
   iv. Percent and timing of hopping in whirlpool
   v. The source and type of hops used

It is also preferred that components are selected such that combined a-and B-acid levels in THYM are greater than 2 mg/g and less than 100 mg/g. In some instances, THYM slurry is mixed with 0.03 to 0.003 parts of an organic acid mix of formic, acetic and propionic acids in volume ratios of 1:2:2 respectively to lower the pH to >4 and kill yeast cells.

Dewatering by filter bag. THYM is pumped into US Fabrics-US 450T Eco Tube, or similar, Dewatering Bags, 40 US Sieve, capacity 25 to 1700 gal, potential flow rate of 20 g/min/sf, which increases the dry matter content from a starting point of approximately 10% to finish of approximately 20%. In some cases, diatomaceous earth is added to THYM slurries at a rate of 0.5% to 10% (w/v) to improved filtration and drying performance.

THYM may also be dried by one or more of the following techniques: steam heated drum, rotary, fluid bed, agitated mixing, flash, air, or spray dryers to a moisture dry matter content of 88% or higher.

The low moisture THYM is packaged in a shelf stable format for distribution to end user. The product is ideally sealed under vacuum in bags made of Mylar™ or similar low porosity material.

Some beneficial aspects of using and treating THYM as discussed herein are:
Eliminate or at least reduce problematic waste stream for brewers;
THYM slurry has unexpected room temperature storage stability enabling flexible processing;
THYM has positive effects of ruminant digestion;
THYM stimulates positive short chain fatty acid synthesis, e.g propionic acid;
THYM increases bovine and porcine feed efficiency;
THYM significantly (>65%) inhibits bovine rumen methane production in vitro;
THYM is a safe and effective feed supplement which may reduce greenhouse gas emissions from animals; and supplementing pig feed with THYM enhances the flavor of cooked pork.

In a commercial setting, such as a small or craft brewery, the THYM production and collection may be optimized, if desired, by considering and implementing one or more of the following techniques.
1. Analyze production schedule
   a. Craft brewing is typically comprised of a high variety of different styles of beer
      i. Certain styles are more popular based on the time of season
      ii. Each style of beer has different hopping rates
      iii. Lagers and Malty ales have considerably less hopping rates than IPA's
      iv. Goal is to have a normalized and consistent product regardless of time of year or other factors
2. Create plan for trub and yeast harvesting based on brewing schedule
   a. THYM has certain characteristics based on custom mixing of waste products and certain percentages of each coproduct must be harvested and mixed to insure consistency. Additional hops may need to be added to ensure efficacy.
      i. The hot side
         1. Marsh Tun
         a. Milling:
         i. Malted barley is milled to crack grain and expose starchy endosperm to enzymatic modification, and water.
         b. Mashing
         i. Milled grain is combined with a calculated volume of water at a fixed temperature, mineral salts, and organic acids (food grade Lactic Acid) to provide the correct conditions for enzymatic conversion of starches from the grain into extractable sugar.
         ii. Over a 20-to-30-minute period this mixture is allowed to react with enzymes naturally present in the malted barley.
         c. Lauter
         i. Water is run over the Mash and drained through the bottom of the filtration vessel (Mash/Lauter Tun), extracting the sugar solution (Wort) to be boiled in the kettle.
         ii. The Wort is comprised of simple sugars, proteins (tannins), organic acids, mineral salts, plant-based lipids, and some short-chain starches.
         2. (Boil) Kettle
         a. Once mash-in is complete, the wort is transferred to the kettle where it is boiled for 50-75 minutes.
         b. Hops are added to the kettle. These provide flavor positive compounds, such as alpha and beta-acids, which are essential for beer flavor and preservation.
         c. Further mineral salts are added to enhance flavor and provide yeast nutrients.
         d. Clarifying agents (Irish Moss, Carrageenan) Seaweed extract is added to aid in protein coagulation.
         e. Nutrients for yeast during fermentation are added: (Zinc and other micronutrient/mineral blends, autolyzed yeast hulls.)
         f. During the boiling, both beer soluble and non-soluble materials begin to be separated. Dry vegetable cellulose from the hops, and coagulated protein from the Wort form an insoluble byproduct called “Trub” (synonymous: Hot Break).
         a. This hot wort is then transferred to the whirlpool where the wort is “spun” to form a cone of semi-solid Trub.
         b. Trub consists of coagulated vegetable protein solids, dry vegetable matter from hops, entrained sugars and minerals.
         c. Certain limited-production recipes call for the use of other botanicals, food additions (Processed coffee, Cacao nibs/beans, and other herbs.) These are largely removed post-steeping in the hot Wort and do not constitute a large fraction of the Trub which is captured in the Whirlpool vessel.
         4. Knockout
         a. The clarified hot wort is removed from the solid trub by means of Centrifugal filtration action in the whirlpool, and then pumping the clarified wort out of the Whirlpool vessel.
         ii. The cold side:
         1. Fermentation
         a. Hot wort is pumped from whirlpool through a heat exchanger, dosed with oxygen and sent to a fermenter.
         b. The wort gets chilled to the desired fermentation temperature.
         c. Yeast is added by weight to begin fermentation.
         d. The yeast immediately starts to process the sugars into carbon dioxide and alcohol thus creating beer. Time frames vary based on the style of beer and desired result.
         2. Dry Hopping
         a. Hops will be added to the fermenting beer in certain styles.
         b. Hop levels in spent yeast vary based on hopping rates/style.
         c. Dry hopping produces a yeast slurry with a drier consistency, less entrained beer, and a mix of processed hop flowers, insoluble resins and oils, plant proteins and yeast cells.
         3. Yeast Collection
         a. The yeast becomes dormant once sugars are consumed. It can be harvested for reuse if yeast is deemed viable.
         b. Once yeast is spent it must be removed from the Fermenting Vessel (Fermenter)
         c. Standard fermentation produces from 1000 to 2000 lbs. of yeast slurry per tank (Fermenter). This slurry contains plant proteins, yeast cells, plant resins and beer: (alcohol, water, CO2, and organic acids.)
         3. Wet THYM production
         a. Trub from the hot side is custom mixed with spent yeast from the cold side to form wet THYM
         i. Trub is harvested from the whirlpool by rinsing the collected waste cone to a drain in the vessel and is then pumped to holding tank(s) system.
         ii. Yeast is pumped from the fermenter cone to the same holding tank(s) system.
         iii. The two components (can also be) custom mixed to a given recipe specifications until deemed ready for drying process.
         4. Dried THYM production
         a. Determine end user's unique requirements and choose drying technique
         i. Settling and decanting
         1. Let mixture settle for pre-determined time and harvest supernatant to sediment level
         2. Package/ship liquid in appropriate container to customer
         ii. Bag dewatering
         1. Filter bags typically used in sewage waste dewatering perform well with wet THYM-US Fabrics-US 450T Eco Tube, or similar, Dewatering Bags, 40 US Sieve, capacity 25 to 1700 gal, Potential flow rate of 20 g/min/sf moisture content.
         2. Filtering wet THYM for 24 hours results in 10-15% reduction in
         3. Resulting drier mix can be shoveled into buckets or other as dictated by the customer.
         iii. Drum drying
         1. Wet THYM is fed through a drum dryer at specific speed and temperature that results in 4-11% moisture content final product that retains valuable hop acids.
         2. The resulting powder is flash pasteurized and mold resistant.
         b. Testing
         i. THYM must be tested to insure consistency and efficacy
         ii. Moisture content, crude protein, digestible fiber, hop acids (alpha and beta) and other key nutrients and minerals are among the important variables that must be monitored
         iii. Hops can be added as needed to normalize hop acids as some variability can be expected based on several factors
         1. Hopping rate and type of hops (lbs/barrel)
         2. Percent dry hopped
         3. Percent and timing of hopping in kettle
         4. Percent and timing of hopping in whirlpool
         5. The source and type of hops used
         6. It is preferred that components are selected such that combined a
         and b acid levels in THYM are greater than 2 mg/g.
         c. Packaging can vary based on ultimate needs of the customer
         i. Freshly produced wet THYM can be packaged in 5 gallon buckets, IBC totes, or other TBD
         ii. Bag dewatered THYM can be packaged in 5 gallon buckets or other larger vessels as determined by the customer
         iii. Drum dried THYM is shelf stable but packaging is critical
         1. Powder is quickly collected in container at the drum dryer
         2. Mylar bags tend to provide the most protection
         3. Powder is loaded into bags and vacuum sealed
         4. Oxygen scavengers can be added before sealing to reduce oxidation

The embodiments described herein enable small and medium sized brewers to convert their burdensome trub, hop and yeast waste streams into valuable feed, feed supplements, and food products, and reduces their municipal waste disposal load and fees.

Although the product is referred to herein as an animal food product, it may also have application for human food products, additives, and supplements.

Thus, based on the above, a method for producing a convenient food product includes:
collecting a custom mixed brewery co-product including trub, hops, and yeast mix (THYM) where volume ratios of hot trub: to spent yeast can vary from 1:5 to 5:1, and volume ratios of trub to spent yeast can vary from 1:5 to 5:1;
wherein the brewery wastes are captured from fermenter, whirlpool, mash tun, kettle, hopback, and grundies with pumps, sanitary piping, storage tanks, and custom filter bag containers; and
the mixtures are selected such that THYM will have a combined hop acid content (alpha plus beta) greater than 2 mg/g and less than 100 mg/g.

In an implementation of the above method, the brewery THYM is dewatered until moisture content is reduced to between 3 and 93% and wherein moisture reduction is accomplished by using dewatering or sediment filter bags of various capacities (preferred 25 to 1700 gal), filter presses, rotary drum dryers, fluid fed dryers, agitated mixing dryers, flash dryers or spray dryers as necessary to achieve desired results.

Also, based on the above, a food, with potential to feed a wide variety of living organisms, including but not limited to ruminants, comprises trub, hops, and yeast in a custom mix, prepared as described in the method above,.

In an embodiment of the food above, the THYM is pre-treated by addition of small organic acids, including, but not limited to, formic, acetic, propionic, citric, fumaric, lactic and benzoic acids.

Further, based on the above, a method for producing and marketing a high value food product includes:
a. packaging dried THYM in a shelf stable format; and
b. Custom packaging the dried THYM for different end users.

Further, based on the above, a method for producing a convenient food product from brewery waste products includes:
a. collecting a mixture of the brewery waste products, the products comprising trub (hot trub and/or cold trub), hops, and spent yeast; and
b. reducing moisture content of the mixture.

In an implementation of the method above, the collecting comprises collecting the mixture such that the volume ratio of (hot trub): (spent yeast) is between (inclusive) 1:5 and 5:1.

In an implementation of the methods above, the collecting comprises collecting the mixture such that the volume ratio of (hot trub): (cold trub) is between (inclusive) 1:5 and 5:1.

In an implementation of the methods above, the moisture content is reduced to between 3% and 93%.

In an implementation of the methods above, the collecting comprises capturing one or more of the brewery waste products from one or more of the group consisting of:

Fermenter, whirlpool, mash tun, kettle, hopback, grundies with pumps, sanitary piping, storage tanks, and custom bag filters.

In an implementation of the methods above, the collecting comprises selecting one or more of the brewery waste products such that the mixture has a combined hop acid content (alpha plus beta) greater than 2 mg/g and less than 100 mg/g.

In an implementation of the methods above, the selecting comprises selecting an amount of the one or more brewery waste products to be included in the mixture.

In an implementation of the methods above, moisture reduction is accomplished by one or more of the following:
dewatering or sediment filter bags, filter presses, rotary drum dryers, fluid bed dryers, agitated mixing dryers, flash dryers, and spray dryers.

In an implementation of the methods above, the reducing moisture comprises one or more dewatering and sediment filter bags between (inclusive) 25 and 1,700 gallons.

In an implementation of the methods above, further comprising one or more of the following after the moisture reduction:
pelletizing the mixture, sealing the mixture or pellets in vacuum sealed bags, sealing the mixture or pellets in other shelf stable packaging.

In an implementation of the food product or food supplement above, the food product or food supplement is pre-treated by addition of one or more small organic acids selected from the group consisting of formic, acetic, propionic, citric, fumaric, lactic and benzoic acids.

In an implementation of the food product or food supplement above, the food product or food supplement is produced by one of the above methods.

Trub, hops and yeast mix (THYM), a problematic brewery side stream, has high amounts of antimicrobial hop metabolites and positive nutritional effects on rumen digestion. THYM stimulated rumen propionate synthesis, a desirable effect, reduced methane production in vitro and increased bovine feed efficiency in vivo. THYM positively altered the microbiome in chickens. Methods to combine trub, hops and yeast wastes from fermenters, whirlpools, mash tuns, kettle, hopbacks, and grundies with pumps, sanitary piping and storage tanks are disclosed.

Dewatering the mix with specified filter bags caused an unexpected improvement in its stability and rheological properties allowing for greater material handling and drying options including rotary dryers, agitated mixing and flash dryers. This allows producing a dry product suitable for pelletizing and/or packaging. The treated THYM can reduce rumen methane production, improve weight gain in animals, enhance food flavors, and improve brewery revenues by reducing disposal costs and providing a value-added product for sale.

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations may be well known in the art, and because they do not facilitate a better understanding of the present disclosure, a discussion of such elements and operations is not provided herein. The present disclosure is deemed to inherently include all such elements, variations, and modifications to the described aspects that would be known to those of ordinary skill in the art, particularly in view of reading the present disclosure. Any headings used herein are for organizational purposes only and are not meant to be used to limit the scope of the description or the claims.

The terminology used herein is for the purpose of describing particular example embodiments or implementations only and is not intended to be limiting. As used herein, the singular forms “a”, “an”, and “the” may be intended to include the plural forms as well, unless the context clearly indicates otherwise.

The terms “comprises,” “comprising,” “includes,” “including,” “has,” “having,” and variations in form thereof are inclusive or variations in form thereof are intended to be inclusive in a manner similar to the term “comprises” as that term is interpreted when employed as a transitional word in a claim, and therefore specify the presence of stated features, integers, steps, operations, elements, and/or components, but do not preclude the presence or addition of one or more other features, integers, steps, operations, elements, components, and/or groups thereof unless explicitly stated otherwise or the context clearly requires otherwise.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments and implementations.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments and implementations are contemplated, described herein, and set forth in the claims.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

The terms “includes,” “has,” “having,” or “exhibits,” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items.

As used herein, phrases such as “between X and Y” and “between about X and Y” should be interpreted to include X and Y unless expressly stated otherwise or the context clearly indicates otherwise.

Terms such as “about”, “approximately”, “around”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While terms such as vertical, horizontal, upper, lower, bottom, top, and the like may be used herein, it is to be understood that these terms are used for case in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments and implementations preferably or optionally include certain features, elements and/or steps, while some other embodiments and implementations optionally do not include those certain features, elements and/or steps. Thus, such conditional language indicates, in general, that those features, elements and/or steps are used in a permissive sense rather than a mandatory sense, and may not be required for every implementation or embodiment.

The subject matter described herein is provided by way of illustration only and should not be construed as limiting the nature and scope of the claims herein. While different embodiments and implementations have been provided above, it is not possible to describe every conceivable combination of components or methodologies for implementing the disclosed subject matter, and one of ordinary skill in the art may recognize that further combinations and permutations that are possible. Furthermore, the nature and scope of the claims is not necessarily limited to implementations that solve any or all disadvantages which may have been noted in any part of this disclosure. Various modifications and changes may be made to the subject matter described herein without departing from the spirit and scope of, the exemplary embodiments, implementations, and applications illustrated and described herein.

Although the subject matter presented herein has been described in language specific to components used therein, it is to be understood that the scope of the claims is not necessarily limited to the specific components or characteristics thereof described herein; rather, the specific components and characteristics thereof are disclosed as example forms of implementing the disclosed subject matter. Accordingly, the disclosed subject matter is intended to embrace all alterations, modifications, and variations, that fall within the scope and spirit of any claims included herein or that may be written.

The foregoing Detailed Description is intended only to convey to a person having ordinary skill in the art the fundamental aspects of the disclosed subject matter and is not intended to limit, and should not be construed as limiting, the scope of any claims. Further, in the foregoing Detailed Description, various features may be grouped together in a single embodiment or implementation for the purpose of streamlining the disclosure. This method of disclosure is not to be interpreted as reflecting an intention that a claimed embodiment, implementation, or application requires more features than are expressly recited in a claim. Rather, claims reflect patentable subject matter which may lie in less than all features of a single disclosed embodiment, implementation, or application. Thus, all claims which may be present herein are hereby incorporated into the Detailed Description, with each claim standing on its own as a separate embodiment, implementation, or application.

1. A method to produce a food product, the method comprising:
collecting brewery wastes from at least one of: a fermenter, a whirlpool, a mash tun, a kettle, a hopback, or grundies;
the brewery wastes comprising a trub, hops, and yeast mix (THYM), a volume ratio of best trub to spent yeast is between approximately 1:5 and 5:1, inclusive, a volume ratio of hot trub to cold trub is between approximately 1:5 and 5:1 inclusive; and
dewatering the THYM until moisture content is reduced to between approximately 3 and 93%, inclusive.

2. A food product comprising:
a custom mix of trub, hops, and yeast (THYM) with a moisture content of between approximately 3 and 93%, inclusive.

3. An apparatus for producing a food product, the apparatus comprising:
a feed for receiving a trub, hops, and yeast mix (THYM);
first and second rotating drums, the drums rotating in opposite directions, the drums being heated to a temperature of between approximately 85 and 105° C., inclusive, the drums compressing and drying the THYM, the THYM being in contact with a drum for approximately 90 seconds; and
a first scraper for scraping the THYM off the first drum and a second scraper for scraping the THYM off the second drum.

4. (canceled)

5. The method of claim 1, wherein dewatering comprises feeding the THYM through a double drum dryer with a center feed.

6. The method of claim 1, wherein dewatering comprises feeding the THYM through a double drum dryer with a center feed, the double drum dryer having two drums, wherein each drum is heated to a temperature of approximately 85 to 105° C., inclusive.

7. The method of claim 6, wherein the THYM is exposed to a heated surface of at least one drum for approximately 90 seconds.

8. The method of claim 6, wherein the THYM is scraped from a heated surface of at least one drum after the at least one drum has rotated approximately 180 degrees from when the THYM contacted the at least one drum.

9. The method of claim 6, wherein the double drum dryer flash pasteurizes the THYM.

10. The method of claim 6, wherein the THYM is fed through the double drum dryer at a speed and temperature to provide an approximately 4 to 11%, inclusive, moisture content in the food product.

11. The method of claim 1, wherein combined a-hop and β-hop acid levels in the THYM are greater than 2 mg/g.

12. The method of claim 1, wherein combined a-hop and β-hop acid levels in the THYM are less than 100 mg/g.

13. The method of claim 1, and, prior to the dewatering, further comprising mixing the THYM with 0.003 to 0.03 parts of an organic acid mix of formic, acetic and propionic acids, in volume ratios of 1:2:2, respectively to obtain a pH greater than 4.

14. The method of claim 1, wherein a volume ratio of trub to spent yeast in the THYM is between approximately 1:5 to 5:1, inclusive.

15. The food product of claim 2, wherein the THYM is flash pasteurized.

16. The food product of claim 2, wherein the THYM is dried at a temperature of between approximately 85 to 105° C., inclusive, for approximately 90 seconds.

17. The food product of claim 2, wherein combined a-hop and β-hop acid levels in the THYM are greater than 2 mg/g.

18. The food product of claim 2, wherein combined a-hop and β-hop acid levels in the THYM are less than 100 mg/g.

19. The food product of claim 2, further comprising mixing the THYM with 0.003 to 0.03 parts of an organic acid mix of formic, acetic and propionic acids, in volume ratios of 1:2:2, respectively, to obtain a pH greater than 4.

20. The food product of claim 2, wherein a volume ratio of trub to spent yeast in he THYM is between approximately 1:5 to 5:1, inclusive.

21. The apparatus of claim 3, wherein the feeder mixes the THYM with 0.003 to 0.03 parts of an organic acid mix of formic, acetic and propionic acids, in volume ratios of 1:2:2, respectively, to obtain a pH greater than 4.
